(19) United States
(12) Patent Application Publication
(10) Pub. No.: US 2008/0282263 A1
(43) Pub. Date: Nov. 13, 2008

(54) Virtual Event Interface to Support Platform-Wide Performance Optimization

(76) Inventors: Qingjian Song, Shanghai (CN); Wenfeng Liu, Shanghai (CN); Alvin X. Tang, Shanghai (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 10/577,520

(22) PCT Filed: Dec. 30, 2005
(86) PCT No.: PCT/CN05/02416

§ 371 Date: Apr. 27, 2006

(51) Int. Cl. G06F 13/00

(52) U.S. Cl. 719/318

(57) ABSTRACT

A performance analyzer analyzes occurrences of virtual events generated by platform components. A user may define and select the virtual events to be analyzed. The performance analyzer comprises a virtual event provider manager and a plurality of virtual event provider drivers, Each of the virtual event provider drivers is associated with one of the platform components to provide a definition for the virtual events supported by the associated platform component. During a registration process, the virtual event provider manager queries the virtual event provider drivers about the supported virtual events, and provides, the results to the interrupt vector table. Thus, when a selected virtual event occurs, the processor execution may be interrupted and the interrupted instruction may be stored for analysis.

### BACKGROUND

1. Field of the Invention

Embodiments relate to software techniques for optimizing the performance of a computing platform.

2. Background

A performance analyzer is a tool for performing profiling operations, which is a process of generating a statistical analysis to measure resource usage during the execution of a program. The result of profiling enables the user to optimize the performance of the portion of the program where CPU cycles are consumed the most. The program may be a user application or a system program such as an operation system (OS) program. One example of a performance analyzer, the Intel Vtune®, is a product of Intel Corporation located in Santa Clara, Calif.

One important procedure of profiling is to identify those functions and subroutines that consume significant numbers of CPU cycles. A performance analyzer typically reveals the “hot” code paths—the sets of functions and subroutines most actively invoked. In a large application, the time spent by a compiler to search for optimization opportunities may grows exponentially with the number of modules it is asked to consider. Thus, optimization efficiency improves if the user can identify the most critical modules and functions in their application. Optimization techniques may be applied to these identified modules and functions to achieve better data prefetching, parallelization, and reordering of instructions. The optimization may reduce the numbers of stalled cycles and increase the program execution speed.

Conventional performance analyzer is processor event-driven. That is, the analyzer collects information only when a processor event occurs. A processor event refers to an event generated by the central processing unit (CPU) that causes an interruption of instruction execution of the processor. Processor events (or equivalently, CPU events) include a cache miss, branch misprediction, and any event that causes a stalled cycle in the execution pipeline. However, a user is currently unable to consider events generated by platform components that share the same platform with the CPU. These platform component events may be correlated with instruction execution and may provide useful information for performance optimization.

### BRIEF DESCRIPTION OF THE DRAWINGS

Embodiments are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of an embodiment of a computing platform on which a performance analyzer is executed concurrently with the execution of an application.

FIG. 2 is a block diagram of an embodiment of the performance analyzer of FIG. 1.

FIG. 3 is a diagram showing an embodiment of a registration process of the performance analyzer.

FIG. 4 is a flowchart showing an embodiment of an operation of the performance analyzer.

### DETAILED DESCRIPTION

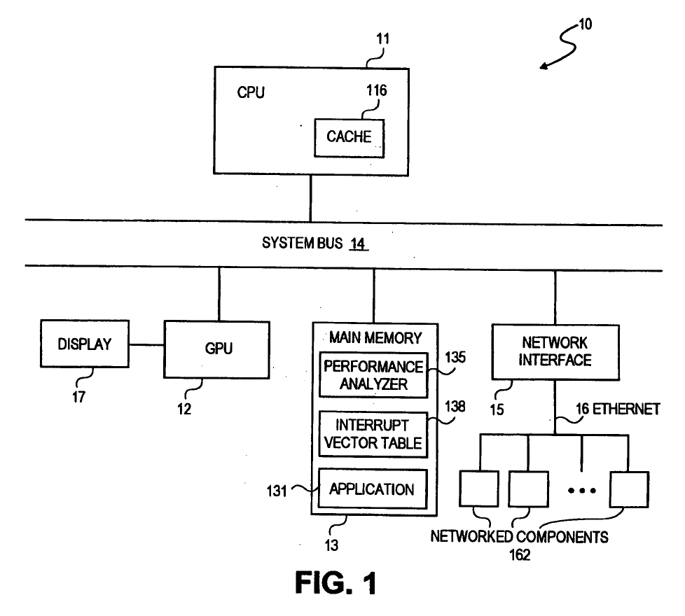

FIG. 1 illustrates an embodiment of a computing platform 10 including a central processing unit (CPU) 11 having a cache 116 therein and a plurality of platform components. The platform components may include a graphics processing unit 12 (GPU), a main memory 13, an interconnect path (e.g., a system bus 14 or a point-to-point connection), a network interface 15, a network (e.g., an Ethernet 16) coupled to a number of networked components 162, and a display 17 coupled to GPU 12. Computing platform 10 may include other platform components for processing, control, transmission, storage, or any other purposes.

Main memory 13 may include a system area for storing system level instructions and data (e.g., operating system (OS) and system configuration data) which are not normally accessible by a user. Main memory 13 may also include a user area for storing user programs and applications (e.g., application 131). Although shown as one memory component, main memory 13 may comprise a plurality of memory devices including read-only memory (ROM), random access memory (RAM), flash memory, and any machine-readable medium.

In one embodiment, a performance analyzer 135 is stored in the system area of main memory 13. Performance analyzer 135 allows a user of platform 10 to monitor instruction execution by CPU 11 when a pre-determined event occurs. An event may be a processor event generated by CPU 11. For example, a processor event may be a cache miss when an instruction or data to be used by CPU 11 is not found in cache 116. A processor event may be a branch misprediction when a conditional statement predicted to be true does not actually become true. An event may alternatively be a virtual event generated by any one of the platform components. For example, a virtual event may be a V_sync generated by GPU 12 at the end of displaying a frame, or a bus throughput generated by Ethernet 16 each time a predetermined number of packets are delivered. A virtual event may be an event triggered by a signal generated by a platform component (e.g., V_sync) or an event defined by a user (e.g., number of packets delivered). Performance analyzer 135 provides a user interface for a user to select one or more of the processor events, and to define and select one or more of the virtual events to be monitored, recorded, analyzed, and reported.

When an event occurs, the event triggers an interrupt in CPU 11. The instruction currently executed by CPU 11 is temporarily suspended. The suspended instruction is referred to as the “interrupted instruction.” The CPU 11 may consult an interrupt vector table 138 to locate an interrupt service routine (ISR) for handling the interrupt. Interrupt vector table 138 may reside in the system area of main memory 13. The base address of interrupt vector table 138 may be stored in an internal register of CPU 11 to be readily accessible by the CPU at all times. Interrupt vector table 138 stores a plurality of interrupt vectors, each of which serves as an identifier to an ISR. The ISR saves the status of the interrupted CPU 11 and performs pre-defined operations to service the interrupt. Each ISR may service one or more processor events or virtual events. For example, virtual events generated by the same platform components may have the same interrupt vector and be serviced by the same ISR.

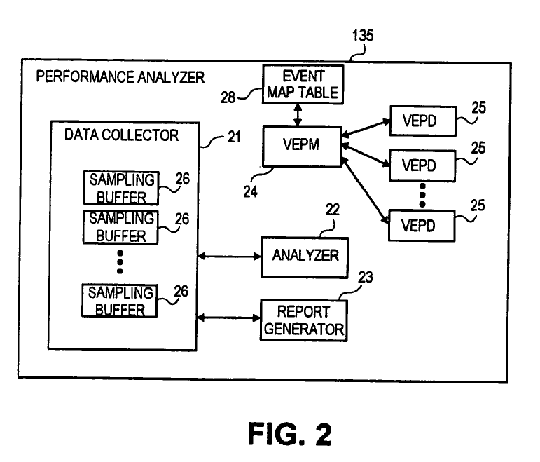

Referring to FIG. 2, an embodiment of performance analyzer 135 includes a data collector 21 for collecting information when an interrupt occurs, an analyzer 22 for producing statistical analysis based on the collected information, and a report generator 23 for generating a report of the analysis. Data collector 21 may include a plurality of sampling buffers 26. One of the sampling buffers may be assigned to store the information of all of the processor events to be analyzed. Each of the other sampling buffers 26 may be assigned to each of the platform components generating the virtual events selected by the user. Sampling buffers 26 may store the interrupted instructions when the selected virtual events or process events occur. Sampling buffers 26 may also store other information relating to the selected events, e.g., information of the instruction module containing the interrupted instruction. Analyzer 22 and report generator 23 have access to the collected information in sampling buffers 26 to perform analysis and report generation.

In one embodiment, performance analyzer 135 includes a Virtual Event Provider Manager (VEPM) 24 and a plurality of Virtual Event Provider Drivers (VEPDs) 25, both implemented as software stored in the system area of main memory 13. Each of the platform components may be associated with one VEPD 25. VEPD 25 supplies a definition for every virtual event supported by the associated platform component. A definition of a virtual event may include an event name, a description, and an interrupt vector that will be generated by the VEPD 25 when the virtual event occurs. For example, a graphics display device driver (i.e., the VEPD 25 of GPU 12) may store a definition (event_name: V_Sync, description: vertical sync signals occurring during a frame display, interrupt vector: PCI_Interrupt#11) for V_sync events. Additionally, each VEPD 25 may also supply a local index, a.k.a., an event_id, for each of its supported virtual events. The local index may be an integer number that uniquely identifies a virtual event within a VEPD 25.

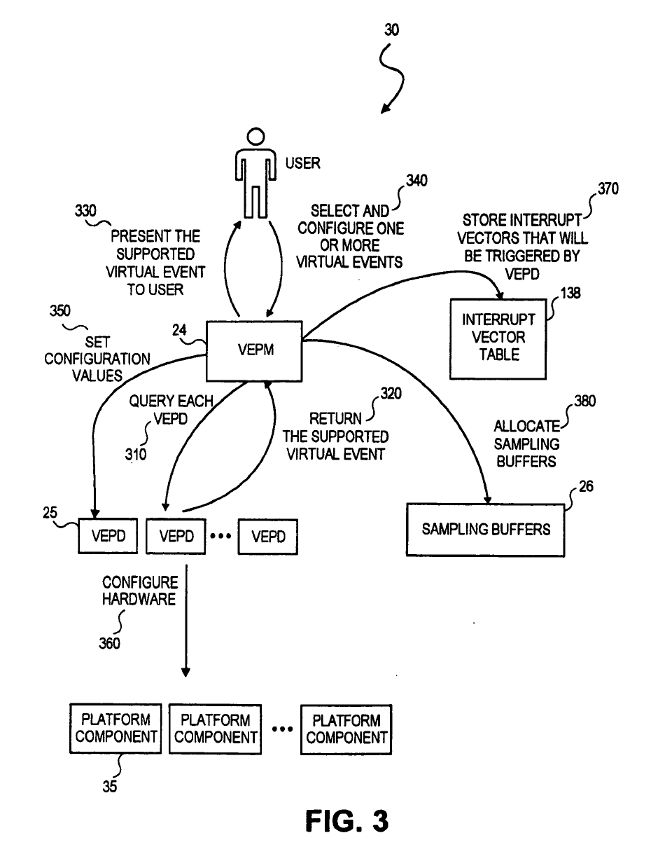

FIG. 3 shows an embodiment of a registration process 30 of performance analyzer 135 for registering the supported virtual events. At 310, VEPM 24 queries each VEPD 25 about the virtual events supported by its associated platform component 35. The query may be in the form of VEPD::QuerySupported Events (event_id, event_name, interrupt vector). At this point the parameters in the parenthesis are dummy variables, the value of which will be returned by VEPD 25. At 320, VEPD 25 returns a supported virtual event list in the form of a list of (event_id, event_name, interrupt vector). The event_id returned by VEPD 25 may be the local index of the virtual event supported by the VEPD. VEPM 24 may assign a platform-wide event_id to each of the supported virtual event. The mapping of a VEPD local index to a platform-wide event_id may be stored in an event map table 28 (shown in FIG. 2) accessible by VEPM 24. Event map table 28 is shown to reside within performance analyzer 135, but may alternatively reside within any portion of the system area of main memory 13.

VEPM 24 also interfaces with a user who may select the virtual events to be analyzed. At 330, VEPM 24 populates all of the supported virtual events on a user interface. These virtual events may include user-defined events as well as hardware events generated by platform components 35. These virtual events may be presented alongside with processor events for user selection. At 340, the user selects one or more virtual events to be analyzed by performance analyzer 135. One or more of these virtual events may be pre-defined by the user. At the same time, the user may also select one or more processor events to be analyzed by performance analyzer 135.

The user may also specify configurable items of the virtual events through the user interface. For example, sampling parameters may be specified by the user. As sampling buffers 26 may not have enough space to store information of every occurrence of a selected virtual event, only a fractional portion of the occurrences are sampled and stored. The user may specify a sampling period during which performance analyzer 135 will run and a sampling rate to define how often an occurrence of a virtual event will be stored. At 350, VEPM 24 configures each VEPD 25 with these user-specified configuration values. For example, the user may specify an “after_value” which defines the rate of sampling. An “after_value” of 10 means one virtual event is sampled out of every ten occurrences of the same virtual event. Thus, an “after_value” of 10 corresponds to a sampling rate of 0.1. After the user specifies the after_value for a virtual event, VEPM 24 configures the VEPD 25 associated with the platform component 35 generating the virtual event with the command VEPD::setEventAfter value(event_id, after_value). In one embodiment, the event_id in the command may be the local index of the virtual event supported by the VEPD 25 that receives the command. After receiving the command, at 360, VEPD 25 configures the associated platform component 35 with the specified configuration value. Thus, VEPM 24 and VEPDs 25 provide a forwarding mechanism to forward configuration values to platform components 35, thus allowing a user to configure these platform components.

At 370, VEPM 24 stores the interrupt vectors of the selected virtual events into interrupt vector table 138 (FIG. 1). At 380, VEPM 24 allocates a separate virtual event sampling buffer 26 (FIG. 2) to each of the VEPDs 25 that generates the selected virtual events. As multiple virtual events may occur at the same time (e.g., a CPU cache miss event may occur at the same time as a GPU V_sync event), the separate sampling buffers allow information of different virtual events to be separately stored and analyzed. Each of the buffers 26 are set up such that each sampling record is time-stamped when stored. Thus, final data in different buffers can be easily correlated by the time-stamps to provide the user an insight to the performance of the platform. Registration process 30 is completed after the allocation of the sampling buffers 26.

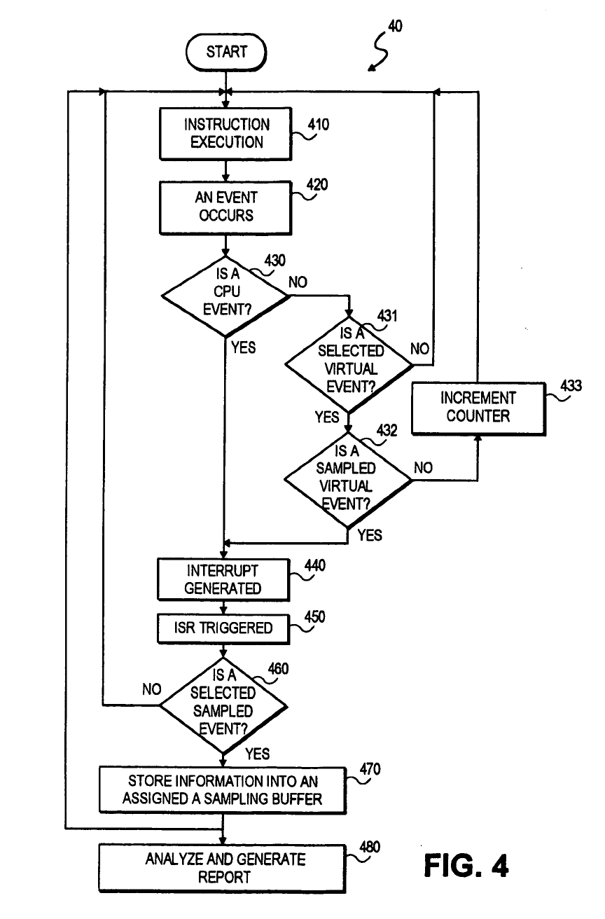

FIG. 4 shows a flowchart 40 of an embodiment of the operation of performance analyzer 135. CPU 11 of FIG. 1 executes instructions of an application program, e.g., application 131 of FIG. 1 (block 410). During the instruction execution, an event occurs (block 420). If the event is a processor event (block 430), a processor event interrupt is generated and the CPU execution is suspended (block 440). If the event is a virtual event which is not selected by the user (block 431), the instruction execution continues without interruption (block 410). Otherwise, if the event is a virtual event which is selected by the user (block 431), the platform component generating the virtual event determines if the virtual event is a sampled event (block 432). The virtual event is a sampled event if the after_value for that virtual event has been reached. If the selected virtual event is not a sampled event, an internal counter maintained by the platform component is incremented (block 433) and the instruction execution continues without interruption (block 410). Otherwise, if the virtual event is a sampled event, the platform component generates a virtual event interrupt and the CPU execution is suspended (block 440). The internal counter keeping track of the after_value may be reset at this point.

At block 440, the virtual event interrupt signals CPU 11 with an interrupt vector, which can be located in interrupt vector table 138 of FIG. 1. The interrupt vector is read and its associated ISR is identified. The identified ISR is triggered to handle the interrupt operation (block 450). The operations of blocks 440 and 450 are performed for all of the processor events and the selected and sampled virtual events. However, performance analyzer 135 analyzes only the selected and sampled event, whether processor events or virtual events. At this point, a process event may not be a selected and sampled event. If the event that causes the interrupt is a selected and sampled event (block 460), data collector 21 of FIG. 2 stores the interrupted instruction and other information relating to the selected and sampled event into an assigned sampling buffer 26 (block 470). When the instruction execution reaches a pre-determined point, e.g., a predetermined time limit, a pre-determined instruction line, or the end of application 131 of FIG. 1, analyzer 22 produces statistical analysis of the stored data and report generator 23 generates a report (block 480). The statistical analysis performed by analyzer 22 may include, but is not limited to, calculating a frequency of the selected virtual event occurring when an instruction module is executed. For example, analyzer 22 may calculate that, out of 100 sampled occurrences of a virtual event, 10 sampled occurrences or 0.1 percent take place when a subroutine is executed. The report generated by report generator 23 allows a user to identify the instructions being interrupted at a time the selected virtual events occur.

In one embodiment, the analysis reported to a user may include the percentage of occurrences of a particular event in the subroutines of application 131. For example, if V_sync is the selected virtual event and application 131 includes subroutines sub_a, sub_b, and sub_c, the report may show that the percentage of the V_sync occurrences in sub_a, sub_b, and sub_c are 97%, 2%, and 1%, respectively. Thus, the user may recognize that sub_a is a hotspot with respect to V_sync. The user may find out more detailed information to correlate the instructions of sub_a with V_sync by selecting sub_a (e.g., a sub_a icon) on the user interface. If sub_a further includes subroutines sub_a1, sub_a2, and sub_a3, the report may show that the percentage of the V_sync occurrences in sub_a1, sub_a2, and sub_a3 are 5%, 90%, and 5%, respectively. The user may continue this process to go down the subroutine hierarchies until the bottom of the hierarchy is reached.

With the wealth of information revealed by performance analyzer 135, the user is better equipped with knowledge to fine-tune the performance of the program. The user may be able to recognize a correlation between the program instructions and the occurrences of events generated by any platform components. The user may recognize hotspots in the program and realize why cycles are being spent there. The exact cause of inefficiency may also be identified.

In the foregoing specification, specific embodiments have been described. It will, however, be evident that various modifications and changes can be made thereto without departing from the broader spirit and scope of the appended claims. The specification and drawings are, accordingly, to be regarded in an illustrative rather than a restrictive sense.

What is claimed is:

1. A method for an event analyzer comprising:
providing a plurality of virtual events supported by a platform for selection, wherein the virtual events are generated by a plurality of platform components;
interrupting execution of an instruction at a time a selected virtual event occurs;
storing the interrupted instruction; and
analyzing the selected virtual event.

2. The method of claim 1 further comprising:
providing a driver interface to associate with each of the platform components, wherein the driver interface supplies a definition of the virtual events generated by the associated platform component.

3. The method of claim 1 further comprising:
allocating a sampling buffer for the platform component generating the selected virtual event to store the interrupted instruction.

4. The method of claim 1 further comprising:
providing a user interface to receive a user definition of the virtual events.

5. The method of claim 1 wherein analyzing the selected virtual event comprises:
calculating a frequency of the selected virtual event occurring at a time an instruction module is executed.

6. The method of claim 1 wherein storing the interrupted instruction further comprises:
time-stamping the interrupted instruction.

7. The method of claim 1 further comprising:
assigning an interrupt vector to the selected virtual event, wherein the interrupt vector is accessed at a time the selected virtual event occurs.

8. The method of claim 1 further comprising:
reporting an analysis at a time the instruction execution reaches a user-specified time limit.

9. The method of claim 1 wherein storing the interrupted instruction further comprises:
storing information of an instruction module containing the interrupted instruction.

10. A system of an event analyzer comprising:
a processor to execute instructions;
a plurality of platform components sharing a platform with the processor;
a plurality of virtual event provider drivers, each of the virtual event provider drivers being associated with one of the platform components to provide definitions for virtual events supported by the associated platform component; and
a virtual event provider manager to query the virtual event provider drivers about the supported virtual events, wherein the virtual event provider manager causes selected virtual events to be analyzed.

11. The system of claim 10 further comprising:
a plurality of sampling buffers, each of the sampling buffers being assigned to each of the platform components that generate the selected virtual events, the sampling buffers storing the instructions being interrupted at a time the selected virtual events occur.

12. The system of claim 10 the virtual event provider manager and virtual event provider drivers further comprise:
a forwarding mechanism to forward user-specified configuration values to the platform components.

13. The system of claim 10 further comprising:
a report generator to generate a report that allows a user to identify the interrupted instructions.

14. The system of claim 10 further comprising:
an event map table accessible by the virtual event provider manager to store a mapping between local indices of the support virtual events and platform-wide event identifiers.

15. The system of claim 10 wherein the virtual event provider drivers respond to the query by sending an event identifier and an interrupt vector for each of the supported virtual events.

16. A machine-readable medium having instructions therein which when executed cause a machine to:
provide a plurality of virtual events supported by a platform for selection, wherein the virtual events are generated by a plurality of platform components;
interrupt execution of an instruction at a time a selected virtual event occurs;
cause the interrupted instruction to be stored; and
cause the selected virtual event to be analyzed.

17. The machine-readable medium of claim 16 further comprising instructions operable to:
allocate a sampling buffer for the platform component generating the selected virtual event to store the interrupted instruction.

18. The machine-readable medium of claim 16 wherein interrupting execution of an instruction further comprises instructions operable to:
interrupt the execution at a predetermined sampling rate.

19. The machine-readable medium of claim 16 wherein causing the selected virtual event to be analyzed further comprises instructions operable to:
calculate a frequency of the selected virtual event occurring at a time an instruction module is executed.

20. The machine-readable medium of claim 16 wherein causing the interrupted instruction to be stored further comprises instructions operable to:
time-stamp the stored interrupted instruction.

21. The machine-readable medium of claim 16 further comprising instructions operable to:
assign an interrupt vector to the selected virtual event, wherein the interrupt vector is accessed at a time the selected virtual event occurs.

22. The machine-readable medium of claim 16 wherein causing the interrupted instruction to be stored further comprises instructions operable to:
store information of an instruction module containing the interrupted instruction.
